(19) United States
(12) Patent Application Publication
(10) Pub. No.: US 2004/0231937 A1
(43) Pub. Date: Nov. 25, 2004

(54) Aircraft structural components

(76) Inventors: Alan Roy Goodworth, Oxford, CT (US); William Townswend, Stratford, CT (US)

Correspondence Address: Mony R. Ghose, Sikorsky Aircraft Corporation, MS-S316A, 6900 Main Street, Stratford, CT, 06615-9129, US

(21) Appl. No.: 10/742,686

(22) Filed: Dec. 22, 2003

Related U.S. Application Data
(60) Provisional application No. 60/471,855, filed on May 19, 2003.

(51) Int. Cl. F16F 7/12

(52) U.S. Cl. 188/371

(57) ABSTRACT

An energy absorbing frame joint that resists axial loads to predefined level so that when a load greater than the predefined level is applied, the joint permanently and visibly deforms. This visible deformation is caused by connectors ripping through at least one member to which they are connected when an axial load is applied.

### BACKGROUND OF THE INVENTION

1. Technical Field

This invention generally relates to cabin safety. More specifically, this invention relates to an impact absorbing system that allows maximum survivability in an aircraft by allowing limited controlled deformation of the cabin frame to absorb significant impact energy to prevent catastrophic failure.

2. Background Information

Throughout the development of the helicopter, the manufacturers of helicopters have tried to make their helicopters safer. With current designs and ever expanding cabins, the turbine engines that power the aircraft and significant mechanical systems must be located high on the aircraft frame above the cabin. Even though the mechanicals are located out of the way, their relocation has caused a number of problems. One shortcoming of the prior art is that in order to support the weight high up on the helicopter frame, the frame had to be sized so that the vertical members were strong and rigid enough to support the weight in the event of a crash reducing the available cabin space. Another short-coming of the prior art is that the increased size of the required members to support the weight of the mechanicals reduces the payload weight rating. Yet another shortcoming of the prior art is that after a hard landing the members comprising the cabin are not readily inspectable to determine whether the cabin still has structural integrity. Still another shortcoming of the prior art is the high cost of fabrication, inspection and testing.

A need therefore exists for an improved cabin structure that overcomes the aforementioned shortcomings.

### SUMMARY OF THE INVENTION

The present invention overcomes the foregoing disadvantages of the prior art by providing a limited deformable cabin system to absorb crash energy and reduce dynamic crash loads

Accordingly, it is an object of the present invention to provide a comparatively larger interior cabin space by reducing the cross section of frame members.

It is another object of this invention to reduce the basic vehicle weight to increase payload

It is still another object of this invention to provide a readily inspectable structural support system.

Still another shortcoming of the prior art is the high cost of fabrication, inspection and testing.

These and other objects of the present invention are achieved by providing a cabin system with deformable structural side members.

Additional object and advantages of the invention are set forth in the detailed description herein, or will be apparent to those of ordinary skill in the art. Also it should be appreciated that modifications and variations to the specifically illustrated and discussed embodiments and uses of this invention may be practiced without departing from the spirit and scope thereof, by virtue of present reference thereto. Such variations may include but are not limited to, substitution of equivalent parts, parts with equivalent functions, or multiple pieces so that the device has the same function for those shown or discussed.

For a fuller understanding of the nature and objects of the invention, reference should be made to the following detailed description taken in connection with the accompanying drawings, which illustrate, by way of example, the principles of the invention.

### BRIEF DESCRIPTION OF THE DRAWINGS

The preferred embodiment of the invention, illustrative of the best mode in which the applicants have contemplated applying the principles, are set forth in the following description and shown in the drawings and are particularly and distinctly pointed out and set forth in the appended claims.

Similar numerals refer to similar parts throughout the drawings.

FIG. 1 is a perspective view of an undeformed frame member of a cabin system;

FIG. 2 is a perspective view of a deformed frame member of a cabin system;

FIG. 3 is an elevation view of another embodiment of an undeformed frame member; and

FIG. 4 is an elevation view of a deformed frame member according to the embodiment depicted in FIG. 3.

### DESCRIPTION OF THE PREFERRED EMBODIMENT

The detailed description of the present invention is given for explanatory purposes. It will be apparent to those skilled in the art that numerous changes and modifications can be made without departing from the scope of the invention. Accordingly, the whole of the description is to be construed in an illustrative and not a limitative sense. The scope of the present invention is to be limited only to the extent of the claims that follow.

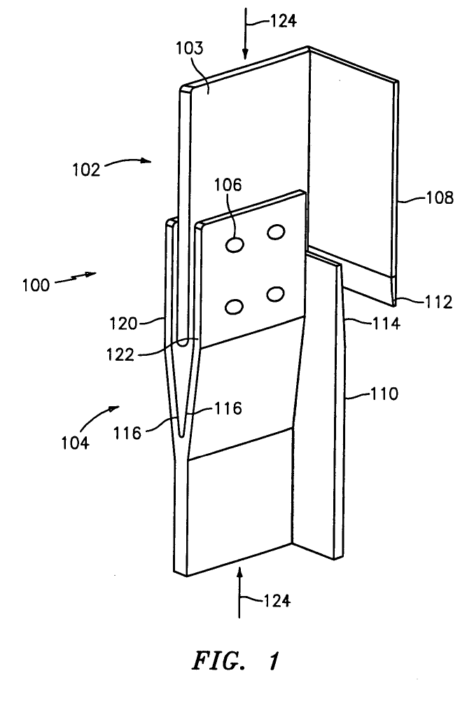

There is a drive throughout the aerospace industry to increase the strength of and durability of aerospace products while significantly reducing the weight of the product. One embodiment of this invention depicted in FIG. 1 shows an energy absorbing deformable frame joint 100 that can be used to join frame members 102 and 104 of an aircraft cabin. The deformable frame joint 100 has a first member 102 and a second member 104. Preferably, the frame members 102 and 104 are matingly engaged. They are connected together by at least one connector 106. Preferably, the connector or connectors are placed in openings (not shown) in branches 120 and 122. The openings in branches 120 and 122 are preferably aligned so as to allow the connectors to be placed in the openings generally perpendicular to the members. The second member is preferably formed in a yoke or y-shape having two branches 120 and 122 so that it can accept member 102. Branches 120 and 122 of second member 104 have a first end and a second end. The second end is the end where branches 120 and 122 join forming a juncture, whereas the first end is the end distal from the juncture or a seat.

In one embodiment of the invention, the second member is formed so that the two branches 120 and 122 taper together to form friction surfaces 116 on the two branches 120 and 122. The first member 102, typically a single tongue, fits in between 120 and 122. As the tongue moves deeper into the seat formed by branches 120 and 122, more of the tongue touches branches 120 and 122, thus increasing contacting surface areas and friction. It is within the scope of the invention to have multiple tongues that form a “W” shape so that the three tongues mate with the 2 branches. By using the multiple tongues, the stiffness of the joint is greatly increased. Also, the frame members can be of various cross sectional shapes: i.e. box, channel, or “I” sections.

In order to provide additional stability, either one of members 102 and 104, but preferably both members 102 and 104, have stabilizing members 108 and 110 respectively. These members help guide members 102 and 104 to their proper engagement in the event of an impact load. Additionally, member 108 may have a tapered end 112 that slides across tapered end 114 of member 110 in the event of a significant load. It is preferred that members 102 and 104 are attached to stabilizing members 108 and 110 to resist buckling of member 102 and 104.

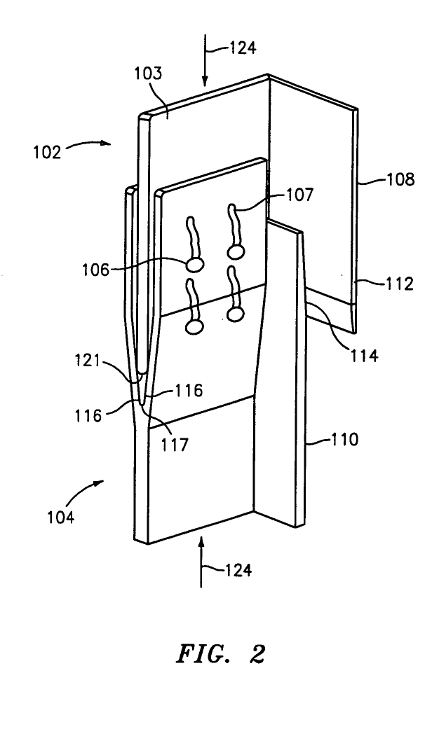

Referring now to FIG. 2, when axial force 124 is applied to members 102 and 104, typically due to an impact, the members 102 and 104 further matingly engage. There are several different forces that resist the axial load 124. Connectors 106 compress branches 120 and 122 around member 103 so that friction may impede axial movement of the members 102 and 104. Surfaces of members that touch another member may be gnurled or modified to have greater friction force to resist relative movement between the members. Another way of resisting the axial force is through the movement of member 102 against the “y” of member 104. As end 121 moves deeper into y member 104, the branches 120 and 122 attempt to resist movement of 121. As the branches 120 and 122 separate, the force required to cause the separation increases as end 121 gets closer to notch 117, especially when the thickness of the branches is greater at notch 117 than at the distal end of the branches. Another method for resisting relative movement is that if the connectors 106 do not have shear failure, the connectors 106 cause one member 102 or 104 to rip. The rip 107 shows the deflection of the members 102 and 104 as a result axial load 124. The thickness of 104 or 102 may be adjusted to provide a constant or ever increasing resistance to the axial load. The rip 107 is a clear visual indicator that a significant axial load has been applied. By determining length of the rip it is possible to calculate the axial force applied to the members 102 and 104 simply by calculating the distance moved and the required amount of force to move it through a certain thickness of the member over the measured distance. Additionally, if a rip is noticed in the inspection of the joint, the members must be replaced. This allows the connections to be readily inspectable.

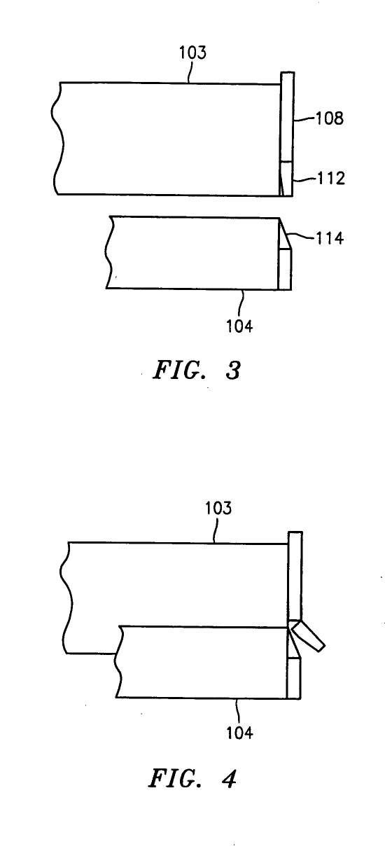

Another method for modifying the joints strength is to have the tapered end 112 move against tapered end 114. At least one tapered end slides underneath the other tapered end. In this case, tapered end 114 moves underneath tapered end 112. The tapered end 114 cause member 108 to deform or separate from member 103 shown in FIGS. 3 and 4. The additional of members 108 and 110 also provide additional stability to the joint, restricting the members of the joint from moving horizontally preventing the joint from moving horizontally. The combination of several of these devices result in a very predictable strength of frame joint 100. Preferably, any energy absorbing frame joint has a web and at least one flange so that buckling may be reduced.

Although the fabrication of these joints in metal such as steel, aluminum or any other metal is possible, the preferred fabrication method is with composites. The members may be fabricated using prepreg or hand laid composites. Additionally, the member may be fabricated using a layered fabrication technique throughout the member or it may be fabricated using a bottom layer and a top layer whereby additional nonlayered material is placed there between.

It is also within the scope of the invention to have various types of crushable materials including, but not limited to, various types of composites, softer and harder steels, ceramics and a variety of geometric shapes. In any event regardless of the shape or the materials, the structural member absorbs crash energy while maintaining structural stability.

Further yet, it should be understood that the foregoing relates only to a preferred embodiments of the present invention, and that numerous changes and modifications may be made therein without departing from the spirit and scope of the invention as defined in the following claims.

1. An energy absorbing frame joint comprising a bifurcated web forming a seat connected to at least one flange, and a tongue that matingly engages the seat supporting normal structural and operational loads.

2. An energy absorbing frame joint according to claim 1, wherein the tongue displaces relative to the seat when an impact load is applied.

3. An energy absorbing frame joint according to claim 1, wherein the seat is made of a composite material.

4. An energy absorbing frame joint according to claim 1, wherein the tongue is made of a composite material.

5. An energy absorbing frame joint according to claim 1, wherein the displacement of the seat relative to the tongue is limited.

6. An energy absorbing frame joint according to claim 1, wherein the tongue and seat are connected with a plurality of connectors.

7. An energy absorbing frame joint according to claim 6, wherein the connectors rip at least one member when an axial load is applied to the frame joint.

8. An energy absorbing frame joint comprising two structural members, a first member having a tapered end, a second member having a deformable tapered end that receives the first member tapered end and deforms after an axial load is applied to the joint.
